(19) United States
(12) Patent Application Publication
(10) Pub. No.: US 2023/0101649 A1
(43) Pub. Date: Mar. 30, 2023

(54) COVERING AND STRAPPING SYSTEMS AND METHODS

(71) Applicant: Raven Engineered Films, Inc., Sioux Falls, SD (US)

(72) Inventors: Jared Ernest Kocer, Sioux Falls, SD (US); Thomas Cedric Stoebner, Harrisburg, SD (US); Roger Walter Wendling, Sioux Falls, SD (US); Andre Alan Harvey, Spring Valley, CA (US); Paul Scott Clark, Sioux Falls, SD (US); Brian David King, Wentworth, SD (US)

(21) Appl. No.: 17/935,102

(22) Filed: Sep. 24, 2022

Related U.S. Application Data
(60) Provisional application No. 63/253,802, filed on Oct. 8, 2021.
(60) Provisional application No. 63/247,946, filed on Sep. 24, 2021.

(51) Int. Cl. A01F 25/13

(52) U.S. Cl. CPC A01F 25/13

(57) ABSTRACT

Disclosed are covering and strapping systems and methods for covering granular product such as grain. An example system includes a cover having a top side and a bottom side, multiple attachment implements directly connected to the top side of the cover, and a plurality of securing straps, each of the securing straps being connected to a respective attachment implement and thereby indirectly connected to the top side of the cover without running through a tunnel. The securing straps can extend beyond the edge of the cover for securing to a structure.

### CLAIM OF PRIORITY

This patent application claims the benefit of priority of J. Kocer et al. U.S. Provisional Patent Application Ser. No. 63/247,946, entitled “COVERING AND STRAPPING SYSTEMS AND METHODS,” filed on Sep. 24, 2021 (Attorney Docket No. 2754.464PRV); and of J. Kocer et al. U.S. Provisional Patent Application Ser. No. 63/253,802, entitled “COVERING AND STRAPPING SYSTEMS AND METHODS,” filed on Oct. 8, 2021 (Attorney Docket No. 2754.464PV2) the benefit of priority of each of which is claimed hereby, and each of which are incorporated by reference herein in its entirety.

### TECHNICAL FIELD

This document pertains generally, but not by way of limitation, to covering and strapping systems and methods and, in particular, systems and methods for covering products such as grain, corn, soybeans, or hay.

### BACKGROUND

Many types of products are stored in outdoor environments including agricultural products such as grain, corn, soybeans, and hay. Covers such as tarps have been used for a long time to cover agricultural products and protect them from the sun and rain. Integra Plastics (article in Grain Journal dated May/June 2010) teaches the use of a webbing system that includes a cover held in place by a series of vertical webbing straps. Lemar Industries (article in Grain Journal dated May/June 2010) also teaches a cover secured over grain using a web-like system of straps. Raven Industries has been selling a strapping system for grain covers, where the straps run through pockets built directly in the cover, for several years. The Fortress™ internal strapping system is an example. Western Ag (article dated Nov. 5, 2010) teaches the use of a hay tarp using straps to secure a polyethylene fabric tarp over hay. Western Ag further teaches using straps in pockets to help tarps stay on in high winds. Similarly, J & M Industries (e.g., U.S. Pat. No. 9,347,239) teaches the use of straps in pockets to secure a tarp over grain.

### OVERVIEW

The present inventors have recognized, among other things, that a problem to be solved can include providing a covering and strapping system that can be efficiently made and installed. They have recognized, for example, that strapping systems with straps running through tunnels or pockets (“tunnels”) integral to a tarp are time consuming to make and problematic to install. The present subject matter can help provide a solution to this problem, such as by providing strapping systems and methods for covering a product (such as grain, corn, soybeans or hay) with a cover (e.g., a tarp) using securing straps indirectly connected to the top of the cover without running through tunnels integral to the cover.

In one example, a covering and strapping system is provided which includes a cover having a top side and a bottom side, multiple attachment implements connected to the top side of the cover, and a plurality of securing straps, where each securing strap is connected to a respective attachment implement and thereby indirectly connected to the top side of the cover without running through a tunnel integral to the cover. The multiple attachment implements can, for example, be welded or adhered to the cover. As described below, an attachment implement can, for example, be a set of load pads, a wide strip (e.g., a strip of webbing), or a strap (e.g., an N30 strap or a string reinforced plastic strap). The securing straps (e.g., an N30 strap or a string reinforced plastic strap) can be stitched or pinned to a respective attachment implement with direct attachment to the cover. The cover can be formed from several sections welded together where one or more of the sections includes one attachment implement and securing strap.

In one example, a covering and strapping system is provided that includes a cover, multiple sets of load pads connected to the top side of the cover, a plurality of securing straps, where each securing strap is connected to a respective set of load pads and thereby indirectly connected to the top side of the cover without running through a tunnel. A securing strap can be connected to a load pad using one or more tags. Each load pad can have a footprint and be adhesively secured to the top of the tarp with an adhesive layer having a smaller footprint. A load pad can further have a flap through which breakaway tab(s) can be inserted. The securing straps can extend beyond the edge of the cover for securing to a structure. An optional strengthening layer can be welded to the cover under each securing strap and set of load pads. The cover can be formed from several sections welded together where one or more of the sections includes one attachment implement and securing strap.

In another example, a covering and strapping system is provided that includes a cover, multiple cover straps (e.g., attachment implements) connected to the top side of the cover, and a plurality of tail straps (e.g., securing straps) connected to the cover straps. Each of the cover straps can have ends at or near edges of the cover. Each cover strap can be connected to two tail straps, one on each end of the cover strap. The tail straps can extend beyond the edge of the cover for securing to a structure. The cover can be formed from several sections welded together where one or more of the sections includes one attachment implement and securing straps.

In another example, a covering and strapping system is provided that includes a cover, multiple wide strips (e.g., webbing strips) connected to the top side of the cover, and a plurality of narrower, securing straps, each securing strap connected to a respective wide strip. The wide strips can be directly connected to the top side of the cover and each narrower, securing strap can be directly connected to a wide strip. The cover can be formed from several sections welded together where one or more of the sections includes one attachment implement and securing strap.

By providing covering and strapping systems that do not have securing straps running through tunnels, the present subject matter can provide one or more of the following advantages. The present systems can be more efficiently made. For example, with the present systems, it is unnecessary to stitch or weld a tunnel to a cover and thread a separate strap through the tunnel. The present systems can be more efficiently installed. For example, the present systems can have straps secured directly or indirectly to a cover thus allowing the straps to be held onto during installation; with freely moveable straps in tunnels, the straps cannot be used as a handhold. Freely moveable straps in tunnels can also become lost in the tunnel during install, such as when an installer tugs on one end of the strap and the other end slides into the tunnel. The present systems can have a lower profile and less wind resistance. Tunnels for straps result in loose fabric that can catch wind. The present systems can be stronger and more durable than covers with straps in integral tunnels, especially where the straps attach to the top of the cover using welds.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example covering and strapping system according to embodiments of the present subject matter.

FIGS. 2-7 illustrate an example covering and strapping system according to embodiments of the present subject matter.

FIGS. 8-11 illustrate an example covering and strapping system according to embodiments of the present subject matter.

FIG. 12 illustrates an example covering and strapping system according to embodiments of the present subject matter.

FIG. 13 illustrates an example covering and strapping system manufacturing method according to embodiments of the present subject matter.

FIG. 14 illustrates an example covering and strapping system manufacturing method according to embodiments of the present subject matter.

FIG. 15 illustrates an example covering and strapping system manufacturing method according to embodiments of the present subject matter.

FIG. 16 illustrates an example covering and strapping system manufacturing method according to embodiments of the present subject matter.

FIG. 17 illustrates an example covering and strapping system according to embodiments of the present subject matter.

FIG. 18 illustrates an example covering and strapping system according to embodiments of the present subject matter.

FIGS. 19-24 illustrate an example covering and strapping system according to embodiments of the present subject matter.

FIG. 25 illustrates an example covering and strapping system manufacturing method according to embodiments of the present subject matter.

FIGS. 26-29 illustrate an example covering and strapping system according to embodiments of the present subject matter.

FIG. 30 illustrates an example covering and strapping system manufacturing method according to embodiments of the present subject matter.

FIGS. 31-36 illustrate an example covering and strapping system according to embodiments of the present subject matter.

### DETAILED DESCRIPTION

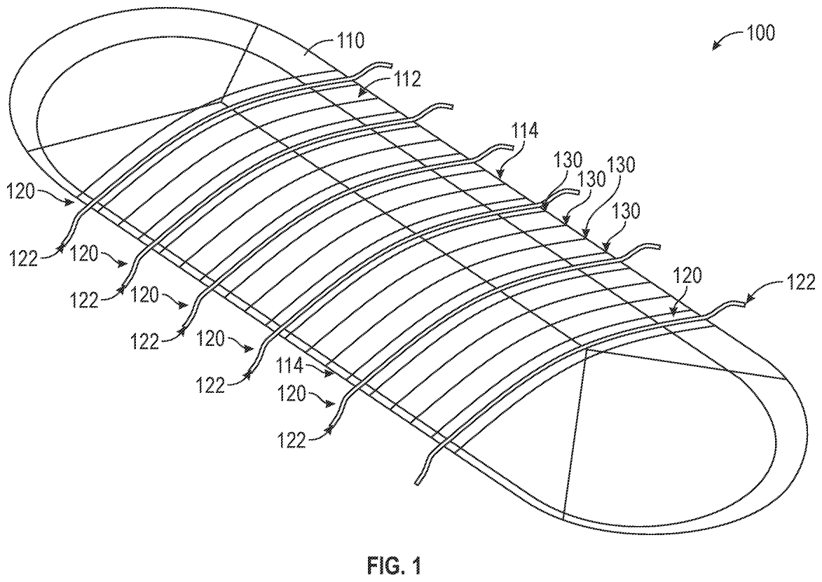

FIG. 1 illustrates an example covering and strapping system 100 without straps in tunnels, according to embodiments of the present subject matter. The system 100 includes a cover 110 having a top side 112 and a bottom side (not shown). The system 100 further includes securing straps/attachment implement systems 120 attached to the top side 112 of the cover 110. The systems 120 have securing strap ends 122 overhanging edges 114 of the cover 110 for securing to a structure, such as ground anchors or weights or a retaining wall (not shown), by rachets, winches or other securing devices. The cover 110 can be made from multiple sections (e.g., 6-12 foot wide sections) which are connected (e.g., overlap welded) together at seams (e.g., seams 130). For example, the cover 110 can be made from polyethylene. In some examples, the cover 110 and can be a sheet (e.g., 6 to 8 feet wide) made from a reinforced plastic sheeting such as Dura-Skrim® or a sheet (e.g., 6 to 12 feet wide) of woven material embedded in plastic. The cover 110 can have a thickness ranging from 8 mil to 14 mil. The securing straps described herein can be formed from a woven webbing or a string reinforced plastic, for example. In an example, securing straps can include an N series strap (e.g., an N300BB (“N30”) or N360BB (“N36”) strap). In another example, an N30 strap is an N series Dura-Skrim® product having a 30 millimeter thickness. In yet another example, an N36 strap is an N series Dura-Skrim® product having a 36 millimeter thickness.

As will be discussed in greater detail below, the covering and strapping system 100 includes multiple attachment implements (e.g., sets of load pads, cover straps, carrier strips, or wide strips) connected to the top side of the cover 110 and securing straps with ends 122 for securing to a structure (e.g., ground or a retaining wall). Each of the securing straps is connected to a respective attachment implement without direct connection to the cover. For example, each attachment implement (e.g., set of load pads, a cover strap, carrier strips, or a wide strip) can be welded or adhered to the cover, and each securing strap can be welded, stitched, or pinned to a respective attachment implement. In this manner, the securing straps are connected to the top side of the cover without running through a tunnel. The covering and strapping system 100 can be used for covering various types of products and is particularly useful for covering granular product, such as grain, corn or soybeans, and hay. In the illustrated example of FIG. 1, the securing straps/attachment implement systems 120 are located on every third or fourth panel with the panels having a width of 6.75 feet and the spacing between securing straps/attachment implement systems 120 of 20.25 feet or 27 feet. In other embodiments, the spacing between securing straps/attachment implement systems 120 can be the same over the whole cover.

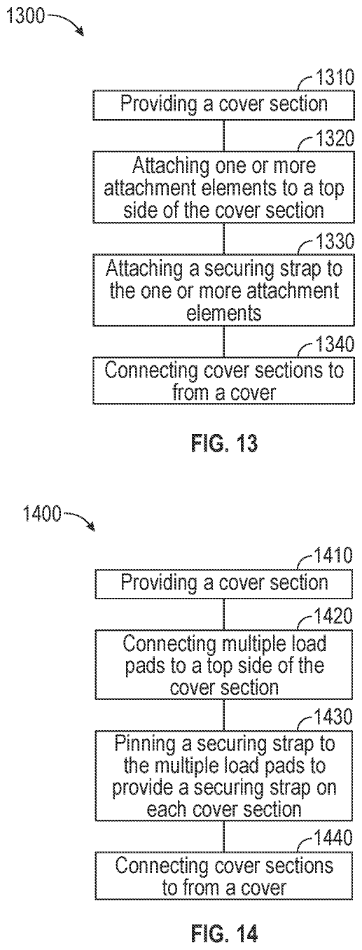

FIG. 13 illustrates a method of manufacturing covering and strapping systems without straps in tunnels according to various embodiments of the present subject matter. The method 1300 is described with regard to a cover formed by connecting multiple cover sections together. The present subject matter is not so limited. The method 1300 can be used to provide securing straps on a cover formed from single piece of material. The method 1300 includes providing a cover section having a top side and a bottom side at operation 1310. The cover section can be formed from a variety of materials including polyethylene. In one example, the cover is made from a reinforced plastic sheet such as Dura-Skrim. In another example, the cover is made from a woven material embedded in plastic. The cover section can have a width of about 6-8 feet in some examples (e.g., with Dura-Skrim) and 6-12 feet in other examples (e.g., with a woven material in plastic).

At operation 1320, an attachment implement is attached to the top side of the cover section. This can include attaching a set of load pads, a wide strip, carrier strip, or a cover strap to the cover section by welding or adhesion. At operation 1330, at least one securing strap is attached to each attachment implement. This can include directly attaching a securing strap to an attachment implement without directly attaching the securing strap to the cover to thereby indirectly connect the securing strap to the top side of the cover without the strap running through a tunnel. For example, a securing strap can be connected by welding, stitching, or pinning to a respective attachment implement. In some examples, a securing strap is connected to an attachment implement before the attachment implement is connected to the cover section. At operation 1340, the cover section can be connected to another cover section (e.g., by welding) and so forth to form a cover. In one example, a cover section can be connected to another before or at the same time an attachment implement is attached to the cover section. A panel of multiple cover sections can be welded together with one of the cover sections including an attachment implement and securing strap(s) and multiple panels can be welded together to form a cover. Additional examples of manufacturing covering and strapping systems are described further below.

Covers with a Set of Load Pads as an Attachment Implement

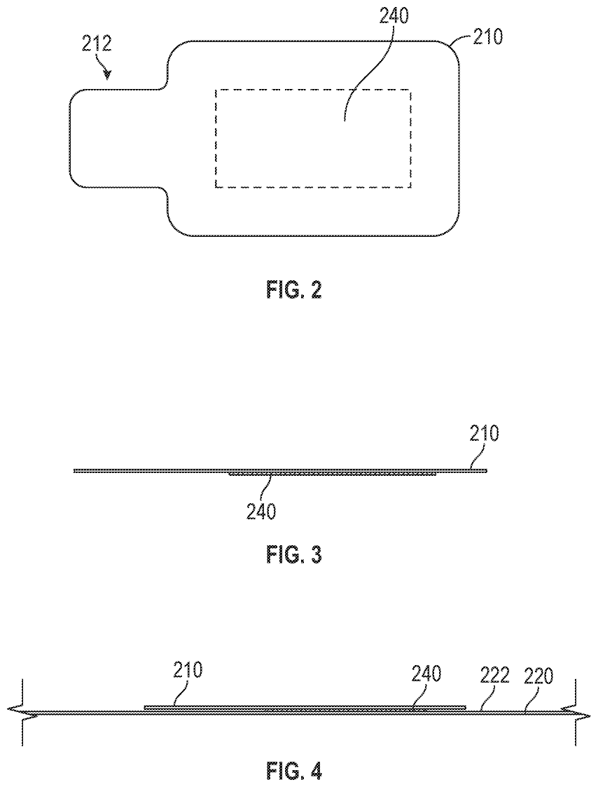

FIGS. 2-7 illustrate an example covering and strapping system 200 according to embodiments of the present subject matter. In these embodiments, multiple sets of load pads 210 are connected to the top of a cover 220 and a securing strap 250 is connected to each set of load pads 210. The cover 220 can be similar to cover 110 discussed above. The cover 220 can, for example, be formed from a series of sections welded together with one or more sections having a set of load pads 210 along its length. The set of load pads can run down the middle of a section or be offset from the middle toward one of the sides of the section.

FIGS. 2-7 show one load pad 210 and one securing strap 250 for illustrative purposes. The system 200 includes multiple securing straps 250 each connected to multiple sets of load pads 210 at intervals along the length of the strap 250 with each securing strap 250 extending over edges of the cover 220 for securing to a structure. In this example, the securing straps 250 run from one end of the cover 220 to the other end of the cover 220 and overhang the edges of the cover 220 for securement to a structure. The securing straps 250 can also be freely moveable after installation through the use of breakable tags discussed below.

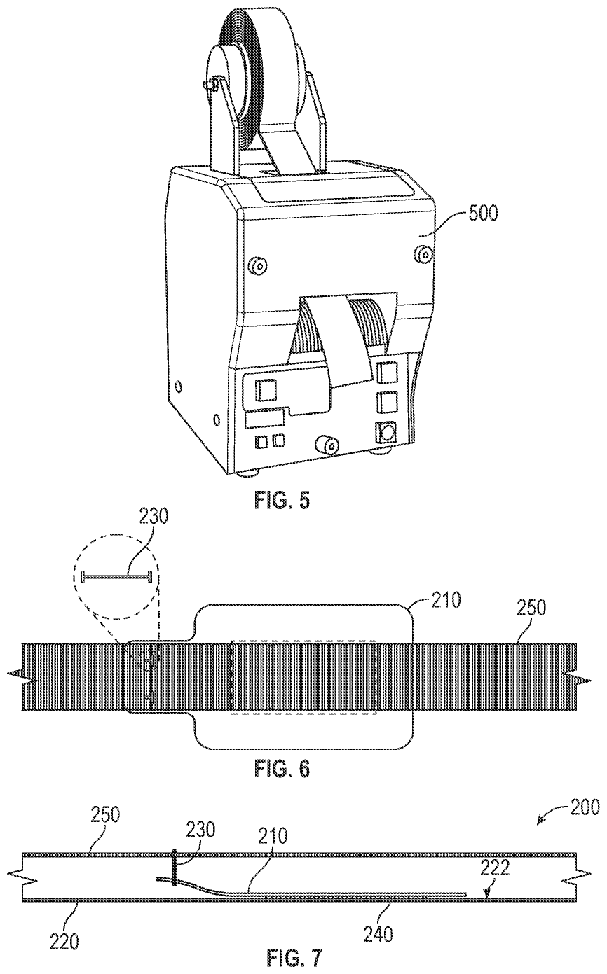

Each load pad 210 is connected to the top side 222 of the cover 220 as best illustrated in FIGS. 4 and 7. Each load pad 210 can be connected to its respective securing strap 250 with one or more tags 230. The tags 230 can, e.g., be clothing tags with barbs that hold the securing strap 250 in place during assembly and pre-installation and that breakaway during or after installation. The load pads 210 can be adhesively secured to the top side 222 of the cover 220 with an adhesive layer 240 such as an adhesive tape. FIG. 5 shows an example of a cutting machine 500 that prepares (e.g., cuts, shapes, patterns, or the like) the adhesive layer 240 for use with the load pad 210. The load pad 210 as best illustrated in FIG. 2 has a footprint that is greater than the footprint of the underlying adhesive layer 240. The load pads 210 can be laser cut or machine cut, for example. Oversizing the load pads 210 relative to their adhesive layers 240 can help prevent adhesive bleeding/material layer blocking which can for example cause a cover section to adhere to itself when rolled up during manufacturing.

In another embodiment, a strengthening layer can be provided between each set of load pads 210 and the cover 220. The strengthening layer can be a layer of string reinforced plastic such as Dura-Skrim and can have a thickness of 12 to 14 mils and a width of 4-5 inches (e.g., wider than width of the load pads), for example. The strengthening layer can be welded to the cover 220 and the load pads 210 adhered to the strengthening layer using an adhesive layer as discussed above. Adding a strengthening layer can help avoid securing straps 250 from cutting into the cover in some applications.

The load pads 210 can further include a pinning tab 212 used for attaching the load pad 210 to the securing strap 250. The pinning tab 212 can be a floating portion of the load pad 210 spaced apart from the adhesive layer 240. The load pad 210 and cover 220 can be made (e.g., cut) from the same material (e.g., Dura-Skrim). Each securing strap 250 can have a width (e.g., 2 inches) that is narrower than a width (e.g., 3-4 inches) of its load pads 210. The pinning tab 212 can be about 2″×2″ square.

In another embodiment, a cushioning layer can be provided between the strap 250 and the cover 220. This can be done prior to attaching the securing strap to the load pads. For example, the securing strap 250 can be attached to or overlay a wider strip of cushioning material (e.g., a geotextile fabric) along the length of the securing strap. The wider strip can have a width of 6-8 inches, for example. The cushioning layer can be attached to the securing strap 250 by, for example, using tags (e.g., barbed tags) or by stitching (e.g., using small patches or rows of stitching). The tabs or stitching can be on long centers of the securing strap 250/cushioning layer to assure alignment. The tags 230 can also extend through the cushioning layer and securing strap 250. Use of a cushioning layer can help reduce or prevent damage (e.g., chafing, cutting, wearing, abrasion, or the like) to the cover 220.

FIG. 14 illustrates a method of manufacturing covering and strapping systems using straps and load pads, without straps in tunnels, according to various embodiments of the present subject matter. The method 1400 is described with regard to a cover formed by connecting multiple cover sections together. The present subject matter is not so limited. The method 1400 can be used to provide load pads and securing straps on a cover formed from single piece of material.

The method 1400 includes providing a cover section at operation 1410. The cover section can be a reinforced plastic sheet or woven fiber in plastic as discussed above. At operation 1420, a set of load pads is attached to the cover section. This operation can include adhering each of the load pads to the cover section with an adhesive layer, where each load pad has a footprint that is greater than a footprint of a respective adhesive layer. This operation can further include adhering a set of load pads along a cover section prior to the section being welded to another. The load pads and cover section can be formed from the same type of material (e.g., reinforced plastic). Optionally, a strengthening layer can be provided between the set of load pads and the cover section. This can be done be first welding the strengthening layer to the cover section then adhering the load pads to the strengthening layer using the adhesive layer.

At operation 1430, a securing strap can be pinned to the set of load pads with one or more tags. The securing strap can be pinned by inserting tags through pinning tabs of the load pads. Prior to operation 1430, a cushioning layer can be provided between the securing strap and the cover as discussed above, for example. The method 1400 can further include breaking the tags to detach the securing strap from its load pads during or after installation. At operation 1440, the cover sections can be connected together to form a full cover. This may be done by welding sections together along seam lines. A panel of cover sections can be welded together with one of the cover sections including a set of load pads. This can be done in a fabrication facility, and the panel rolled up for storage and transportation. In some cases, panels can be secured together in the field using stitching or cable ties, for example. The securing straps can be attached to respective load pad sets in the fabrication facility or in the field, for example.

Covers with a Strap as an Attachment Implement and Tail Straps as Securing Straps

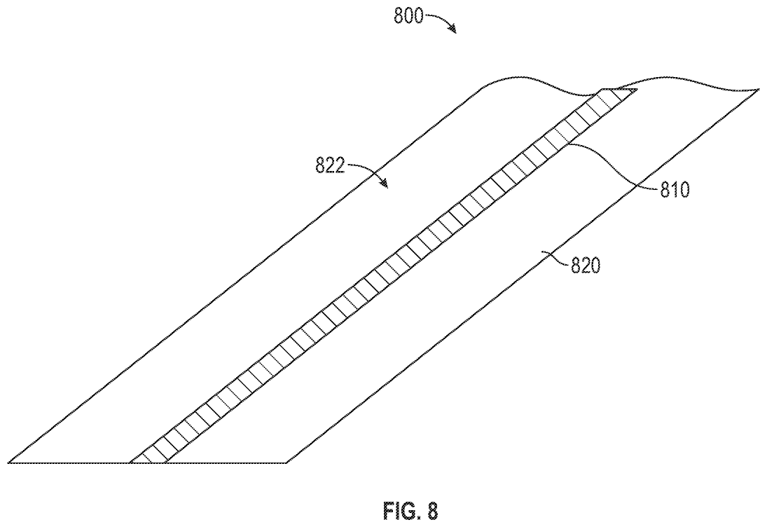

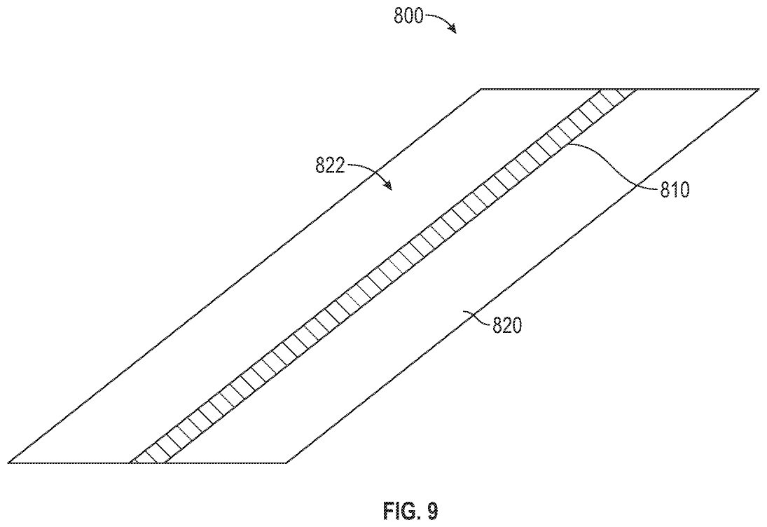

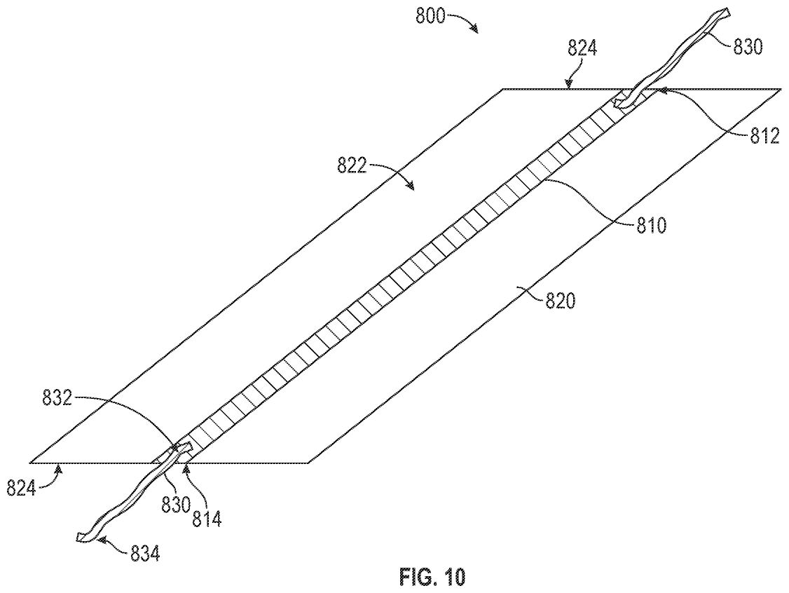

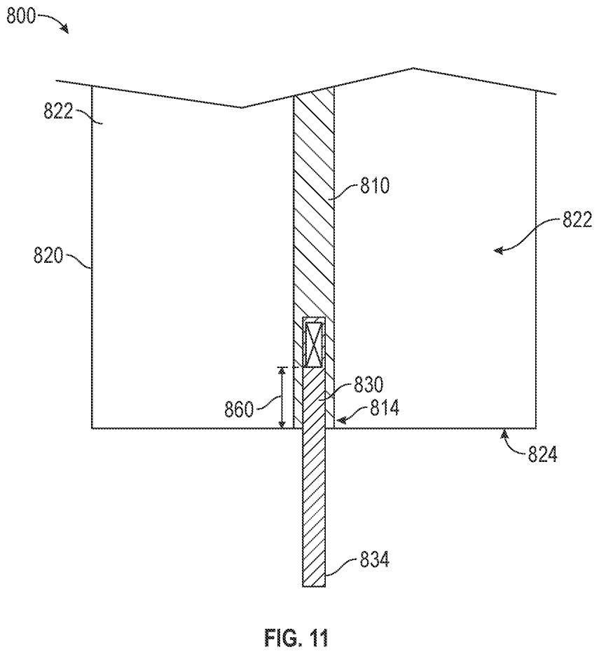

FIGS. 8-11 illustrate another example covering and strapping system 800 according to embodiments of the present subject matter. In these embodiments, the system 800 includes multiple cover straps 810 connected (e.g., welded) to the top side 822 of a cover 820 with each cover strap 810 having tail straps 830 connected at the ends 812, 814 of each cover strap 810. The cover 820 can be similar to cover 110 discussed above. The cover 820 can, for example, be formed from a series of sections welded together with each section having a cover strap 810 running down the middle of a section along its length. FIGS. 8-11 show one cover strap 810 and two tail straps 830 for illustrative purposes. The system 800 includes multiple cover straps 810 each connected at its ends to tail straps 830 (an example is illustrated in FIG. 17). As best illustrated in FIGS. 10 and 11, each tail strap 830 is a securing strap that extends over edges 824 of the cover 820 for securing to a structure. For example, with reference to FIG. 17, during installation, a cover can be cut away near each tail strap and areas of the cover between tail straps can rolled up (e.g., in a board) leaving the tail straps free to be secured to a structure such as a retaining wall (not shown).

With reference to FIG. 11, each cover strap 810 has ends 812, 814 at or near edges 824 of the cover 820. Each tail strap 830 has a first end 832 directly connected to a cover strap 810 at or near the end 814 of the cover strap 810 and a second end 834 extending beyond the edge 824 of the cover 820. Each cover strap 810 can be directly attached to the top side 822 or the cover 820 by, e.g., welding. A cover strap 810 can, for example, be connected to a cover panel section down the middle of the section, as illustrated in FIG. 17. During fabrication, the cover sections and securing straps can be cut from at an edge 824, and a tail strap 830 can be stitched to a cover strap 860 at a location 860 spaced from the edge 824 of the cover 820. Spacing can vary and can for example be in the range of 2-8 feet from the edge of the cover and in one example is 6 feet. Stitching the tails straps at a location spaced from the cover edge can allow for easier installation, allowing the installers to cut away the cover section in the field. The cover straps 810 and tail straps 830 can be formed from the same material such as a string reinforced plastic or woven webbing. While illustrated in the figures as having the same width, the cover strap 810 can have a width of 4-6 inches and the securing straps can have a width of 2 inches, for example.

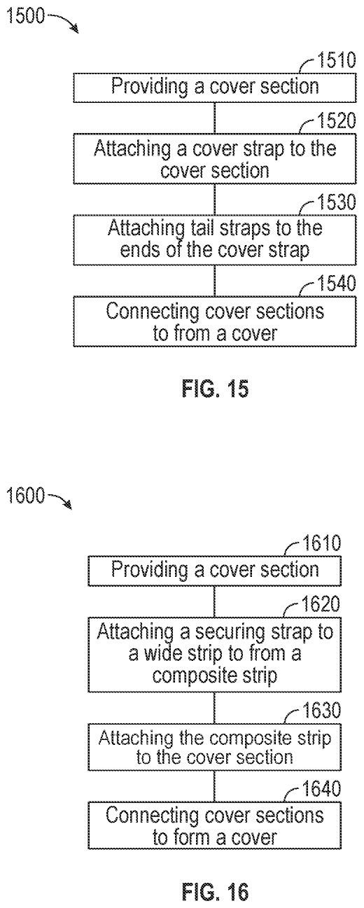

FIG. 15 illustrates a method of manufacturing covering and strapping systems using tail straps, without straps in tunnels, according to various embodiments of the present subject matter. The method 1500 is described with regard to a cover formed by connecting multiple cover sections together. The present subject matter is not so limited. The method 1500 can be used to provide cover straps and tail straps on a cover formed from single piece of material.

The method 1500 includes providing a cover section at operation 1510. The cover section can be a reinforced plastic sheet having a width of about 6-8 feet or a woven material in plastic having a width of 6-12 feet, for example. At operation 1520, a cover strap is attached to the top of the cover section. The cover strap can be attached so that its ends run to or near the edges of the cover section. The cover strap can, e.g., by attached by welding the cover strap to the cover section. This can be done in a fabrication facility prior to installation in the field. The cover section with its cover strap can be rolled up at this time for storage and transportation.

At operation 1530, a tail strap can be attached to each end of the cover strap. This can include connecting each tail strap to a cover strap at locations spaced from an edge of a cover section. For example, each tail strap can be stitched to a cover strap at a location located about 2-8 feet (e.g., 6 feet) from the edge of the cover section. In one example, the cover strap is stitched to a cover section to form a pocket beneath the cover strap and a sewing element is inserted into pocket and used to stitch the tail strap to the cover strap without stitching the tail strap to the cover. The tails straps can be attached to the cover strap at a fabrication facility and the resulting cover section can be rolled up into a master roll.

At operation 1540, the cover section can be connected to another cover section and so forth to form a full cover. This may be done by welding sections together along seam lines. In some examples, multiple cover sections with at least one section having a cover strap are welded together in a fabrication facility and rolled up as a panel for storage and transportation. In the field, depending on the size of the storage area, panels can be secured together using, e.g., stitching or cable ties. In some examples, operation 1530 (attaching tail straps) can be performed before operation 1540 (connecting cover sections together). For example, multiple cover sections can be welded together, then tail straps added to those sections with cover straps, and then the resulting panel can be rolled or folded up for installation in the field. The method 1500 can further include field cutting a cover section and its cover strap) to a desired length.

Covers with Wide Strips as Attachment Implements

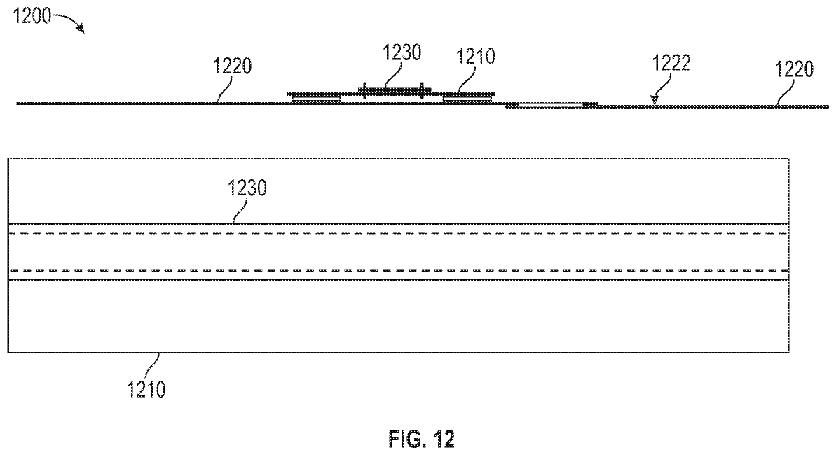

FIG. 12 illustrates another example covering and strapping system 1200 according to embodiments of the present subject matter. In these embodiments, the system 1200 includes multiple wide strips 1210 connected to the top side 1222 of a cover 1220 and a narrower, securing strap 1230 connected to each wide strip 1210. The cover 1220 can be similar to cover 110 discussed above. The cover 1220 can, for example, be formed from a series of sections welded together with each section having a wide strip 1210 and securing strap 1230 running down the middle of a section along its length. FIG. 18 illustrates an example of a cover system with wide strips and securing straps. The location of the wide strip 1210 with securing strap 1230 is not limited to being placed down the middle of a cover section, but can be located at any location on a cover section.

FIG. 12 shows one wide strip 1210 and one securing strap 1230 for illustrative purposes. The system 1200 includes multiple wide strips 1210 each connected to a respective securing strap 1230. Each securing strap 1230 can extend across the cover 1220 and over edges (not shown) of the cover 1220 for securing to a ground or another structure. The wide strips 1210 can have a width that is wider than the width of the securing strap 1230. For example, the wide strips can range from 6-8 inches in width and the narrow strap can be about 2 inches wide. The wide strips 1210 can be welded to the top side 1222 of the cover 1220 and the narrower securing straps 1230 can be stitched to the wide strips without being directly stitched to the cover 1220.

The wide strips 1210 can run from edge to edge on the cover 1220 and the narrower, securing straps 1230 can extend over the edges for securing to a structure. The securing straps 1230 can be formed from a string reinforced plastic or a woven webbing. The wide strips 1210 can be made from can be made from polyethylene such as a reinforced plastic sheeting such as Dura-Skrim®. The wide strips 1210 and cover 1220 can be made from the same material, e.g., cut from the same material. In some examples, the wide strips 1210 and cover 1220 are both made from a reinforced plastic sheeting but with the wide strips 1220 having a greater thickness (e.g., 12-14 mil thick wide strips and 8 mil thick cover). Prior to installation, at a fabrication facility, a securing strap 1230 can be connected (e.g., stitched) to a wide strip 1230 to form a composite strip and the composite strip can be connected (e.g., welded) to a section of the cover 1220. For example, the wide strip of a composite strip can be welded to a cover section while welding the cover section to another section. The composite strip can be located about 24″ from a seam along a line parallel to the seam.

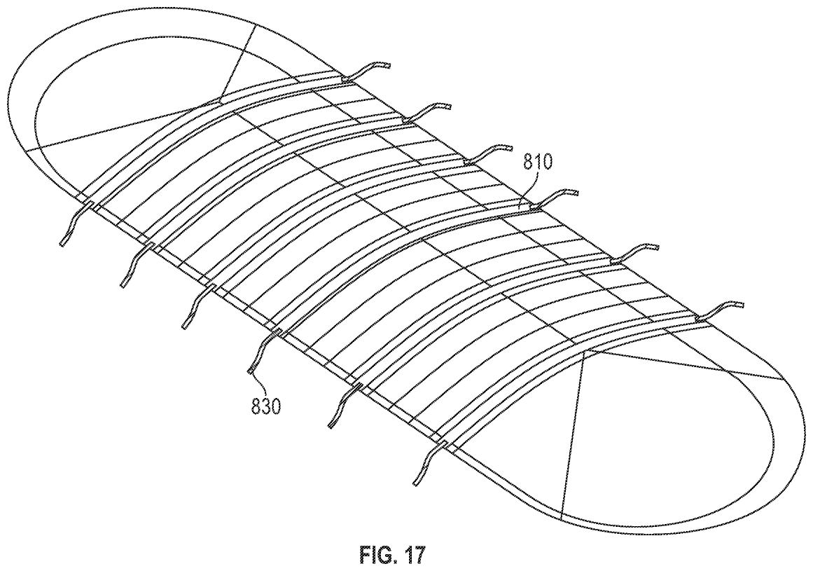

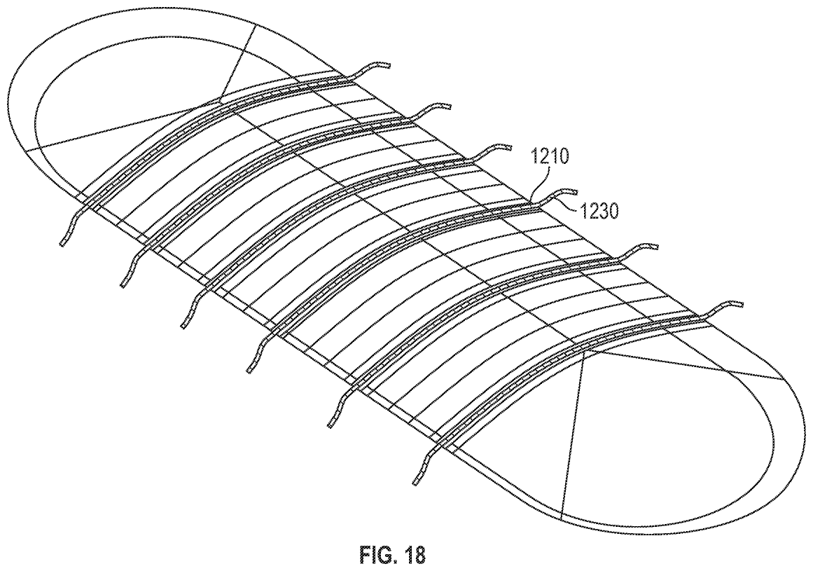

FIG. 16 illustrates a method of manufacturing covering and strapping systems using wide strips and respective straps, without straps in tunnels, according to various embodiments of the present subject matter. The method 1600 is described with regard to a cover formed by connecting multiple cover sections together. The present subject matter is not so limited. The method 1600 can be used to provide cover straps and tail straps on a cover formed from single piece of material.

The method 1600 includes providing a cover section at operation 1610. The cover section can be a reinforced plastic sheet or a sheet of woven material in plastic and can have a width of about 6-12 feet, for example, as discussed above. At operation 1620, a narrower, securing strap is attached to a wide strip to form a composite strip. This can be performed by stitching or welding the securing strap to the wide strip. The securing strap can be an N30 strap or a string reinforced plastic strap, for example. The wide strip can be made from a reinforced plastic sheet, for example. As should be appreciated, a composite strip can be made before a cover section is provided.

At operation 1630, the composite strip is attached to the top side of the cover section. This can be performed by welding the wide strip of the composite strip to the top of the cover section. This allows the narrower, securing strap to be indirectly connected to the cover section without the narrow strap being directly connected to the cover section. The composite strips can, for example, be welded to the cover section during in a fabrication facility before transportation to the field. In some cases, the composite strips can be welded to the cover section around the same time the cover section is welded to another cover section along seams. Operation 1630 can further include extending the composite strip beyond an edge of the cover section to create an excess portion of the composite strip. The method 1600 can further include removing part of the wide strip in the excess portion to leave an end portion of the narrower, securing strap overhanging the cover section for securement to a structure. In some examples, the composite strip can be cut along the sides of the securing strap and a portion of the wide strip can remain below the securing strap in the overhang portion. FIG. 18 illustrates this.

At operation 1640, the cover section can be connected to another cover section and so forth to form a full cover. This may be done by welding sections together along seam lines. In some examples, multiple cover sections with at least one having a composite strip are welded together in a fabrication facility and rolled up as a panel for storage and transportation. In the field, panels can further be secured together using, e.g., stitching or cable ties. FIG. 18 shows an example with three section panels with one of the panels having a composite strip. The composite strips can be attached to cover sections (operation 1630), at a fabrication facility, before, after, or during connection of cover sections (operation 1640).

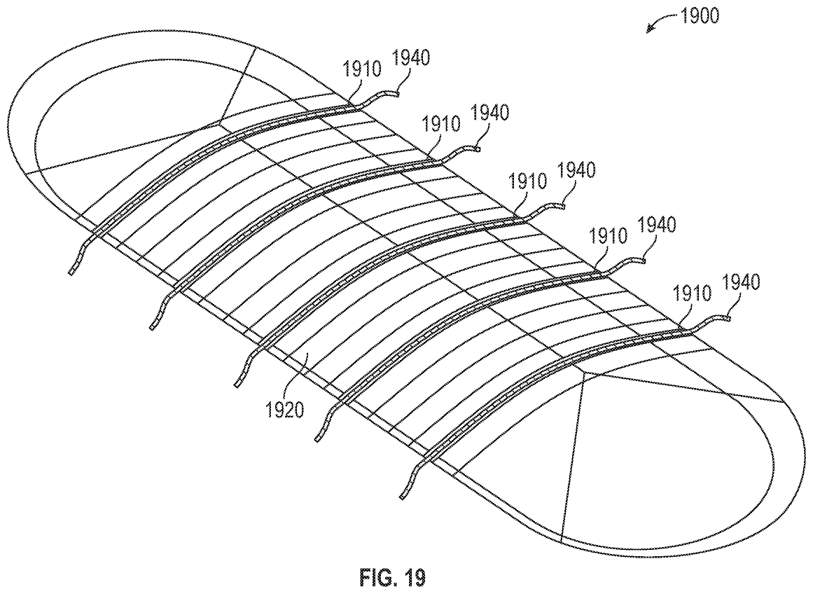

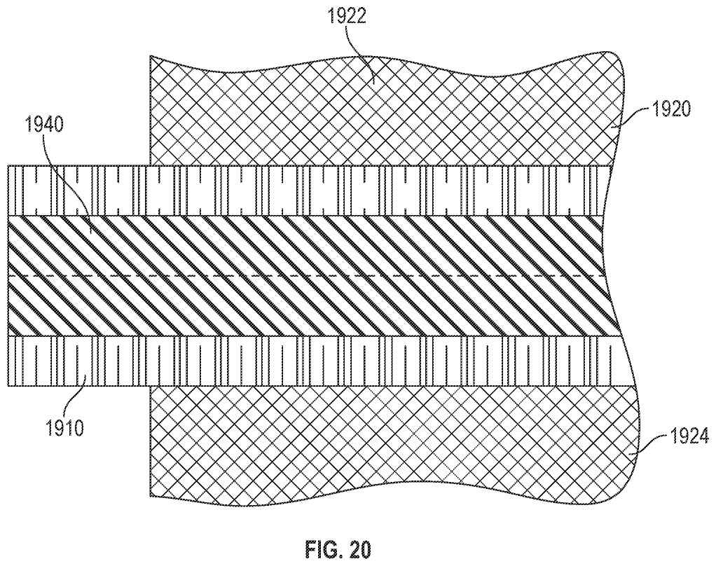

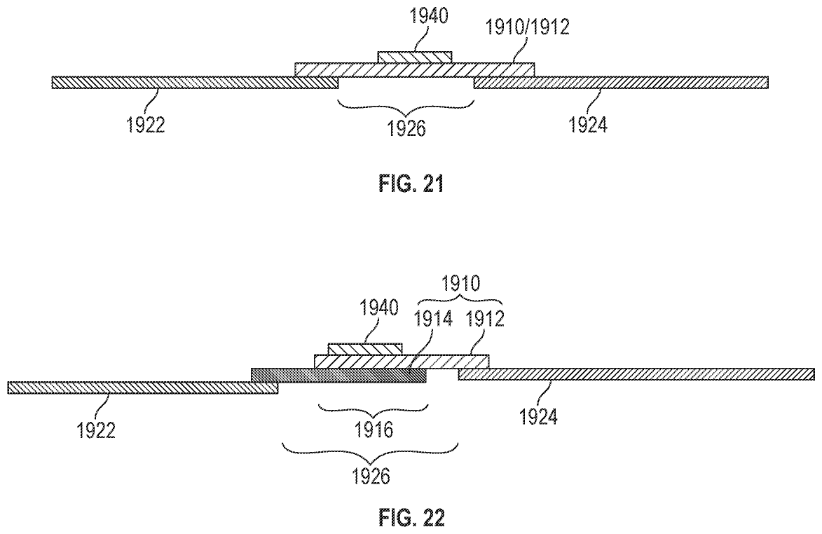

In some examples, a wide strip carrying a securing strap can connect (e.g., by welding) adjacent cover sections. FIG. 19 illustrates an example covering and strapping system 1900 with wide strips 1910 connecting adjacent cover sections, according to embodiments of the present subject matter. In these embodiments, the system 1900 includes multiple wide strips 1910 connected (e.g., welded) to a cover 1920 and connecting adjacent cover sections (e.g., as shown in FIGS. 21-24) with a securing strap 1940 connected (e.g., stitched) to each wide strip 1910. The cover 1920 can be similar to cover 110 discussed above. The wide strips 1910 can be formed from the same material as the cover 1920 and can be welded to the cover using heat welding. FIG. 20 is a top view an example wide strip 1910 with a securing strap 1940 attached to two sections 1922, 1924 of the cover 1920. The securing strap 1940 is attached to the wide strip 1910 and connected to the top side of the cover without running through a tunnel.

FIG. 21 is a side view of an example wide strip 1910 over two sections 1922, 1924 of the cover 1920. The view illustrates the placement of the wide strip 1910 prior to heat welding the wide strip 1910 to the cover 1920. The wide strip 1910 has a width greater than the width of the securing strap 1940. For example, the wide strip 1910 can have a width of 4 to 8 inches and the securing strap 1940 can have a width of 2 inches. FIG. 21 illustrates the wide strip 1910 as a carrier strip 1912 without an underlying strip. The securing strap 1940 can lie between the two cover sections 1922, 1924 and in some examples is approximately centered between the cover sections 1922, 1924. The securing strap 1940 can be stitched or welded to the wide strip and can be centrally located over the cover sections 1922, 1924 over a gap 1926 between the cover sections. Without a layer beneath the wide strip 1910, welding rather than stitching the securing strap 1940 to the wide strip 1910 can provide an enhanced water barrier in this example. As will be discussed further below, the wide strip 1910 carrying the securing strap 1940 can be heat welded to the cover sections 1922, 1924. This can secure the wide strip 1910 and strap 1940 to the cover and also connect the adjacent cover sections 1922, 1924 in a single step.

FIG. 22 is a side view of another example wide strip 1910 over two sections 1922, 1924 of the cover 1920 where the wide strip 1910 includes a carrier strip 1912 and a bottom strip 1914 and the cover sections 1922, 1924 are separated by a gap 1926. In this example, the carrier strip 1912 overlaps the bottom strip 1914 in an overlap portion 1916 and the overlap portion 1916 lies in the gap 1926 between the cover sections 1922, 1924. The securing strap 1940 can be stitched or welded to the wide strip and can be located in the overlap portion 1916. The overlap portion 1916 can have a width that is greater than the width of the securing strap 1940. For example, each of the carrier strip 1912 and the bottom strip 1914 can have a width of about 4 to 6 inches and the overlap portion 1916 can have a width of about 2.5 to 4 inches, leaving the wide strip 1910 with a width of about 5.5 to 8 inches. The cover sections 1922, 1924 can lie beneath the bottom strip 1914 and carrier strip 1912 and outside of the overlap portion 1916. As will be discussed further below, the carrier strip 1912 carrying the securing strap 1940 and the bottom strip 1914 can be heat welded to the cover sections 1922, 1924. This can secure the wide strip 1910 and strap 1940 to the cover and also connect the adjacent cover sections 1922, 1924 in a single step. For example, the bottom strip 1914 can be welded to a top side of the first cover section 1922 and the carrier strip 1912 can be welded to the top side of the second cover section 1924. Where the securing strap 1940 is stitched to the carrier strip 1912, the bottom strip 1914 can provide a seal under the stitching and help prevent water from entering the cover.

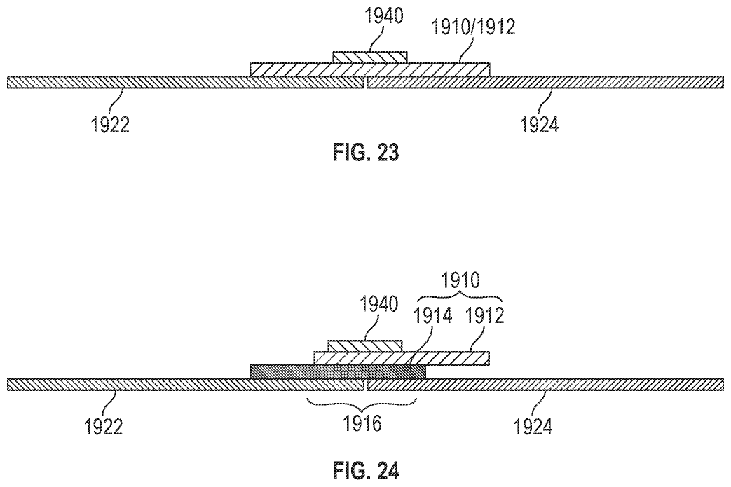

FIG. 23 is an example side view of an example wide strip 1910 over two sections 1922, 1924 of the cover 1920. The view illustrates the placement of the wide strip 1910 prior to heat welding to the cover 1920. The wide strip 1910 has a width greater than the width of the securing strap 1940. For example, the wide strip 1910 can have a width of 4 to 8 inches and the securing strap 1940 can have a width of 2 inches. FIG. 23 illustrates the wide strip 1910 as a carrier strip 1912 without an underlying strip. The securing strap 1940 can lie above the two cover sections 1922, 1924 and in some examples is approximately centered over the cover sections 1922, 1924. The securing strap 1940 can be stitched or welded to the wide strip 1910 (e.g., the carrier strip 1912) and can be centrally located over the cover sections 1922, 1924. As will be discussed further below, the wide strip 1910 carrying the securing strap 1940 can be heat welded to the cover sections 1922, 1924. This can secure the wide strip 1910 and strap 1940 to the cover and also connect the adjacent cover sections 1922, 1924 in a single step.

FIG. 24 is another side view of an example wide strip 1910 over two sections 1922, 1924 of the cover 1920 where the wide strip 1910 includes a carrier strip 1912 and a bottom strip 1914. In this example, the carrier 1912 strip overlaps the bottom strip 1914 in an overlap portion 1916. The securing strap 1940 can be stitched or welded to the wide strip and can be located in the overlap portion 1916. Where the securing strap 1940 is stitched to the carrier strip 1912, the bottom strip 1914 can provide a seal under the stitching and help prevent water from entering the cover. The overlap portion 1916 can have a width that is greater than the width of the securing strap 1940. For example, each of the carrier strip 1912 and the bottom strip 1914 can have a width of about 4 to 6 inches and the overlap portion 1916 can have a width of about 2.5 to 4 inches, leaving the wide strip 1910 with a width of about 5.5 to 8 inches. The cover sections 1922, 1924 can lie beneath the overlap portion 1916 and in some examples the cover sections 1922, 1924 are centered in the overlap portion 1916. The securing strap 1940 can lie above the cover sections 1922, 1924 and in some examples is approximately centered above cover sections 1922, 1924. As will be discussed further below, the carrier strip 1912 carrying the securing strap 1940 and the bottom strip 1914 can be heat welded to the cover sections 1922, 1924. This can secure the wide strip 1910 and strap 1940 to the cover and also connect the adjacent cover sections 1922, 1924 in a single step. For example, the bottom strip 1914 can be welded to a top side of the first section 1922 of the cover 1920 and a top side of the second section 1924 of the cover, and the carrier strip 1912 can be welded to a top side of the bottom strip 1914 and the top side of the second section 1924 of the cover 1920.

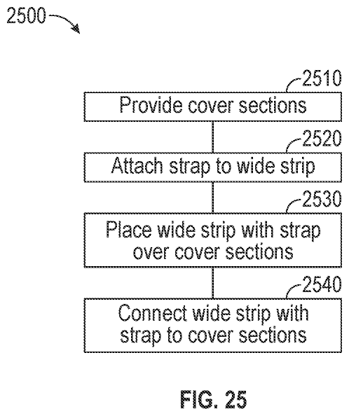

FIG. 25 illustrates a method of manufacturing a covering and strapping system. The method 2500 includes at operation 2510 providing a cover having a first section and a second section. The cover sections can be placed adjacent one another or separated by a gap. The cover sections can be made from a string-reinforced plastic sheet such as Dura-Skrim. At operation 2520, a securing strap can be connected to a wide strip. This can be done by stitching or welding the securing strap to the wide strip. Operation 2320 can occur before operation 2510. At operation 2530, the wide strip with the securing strap can be placed over the adjacent cover sections.

At operation 2540, the method 2500 continues with the wide strip being connected to a top side of the cover. This can include welding the wide strip to the first and second sections of the cover. Operation 2540 can be performed in a fabrication facility, for example. Advantageously operation 2540 allows for the two adjacent cover sections to be connected together and the wide strip to be connected to the cover in a single step. The wide strip being sealed against the cover sections also serves to prevent or reduce water or moisture from entering through the cover.

Optionally, the wide strip can include a carrier strip carrying the securing strap and a bottom strip. For example, operation 2520 can include connecting the securing strap to the carrier strip by stitching or welding, and operation 2530 can include overlapping the carrier strip over the bottom strip. This overlapping of the carrier strip and the bottom strip can include forming an overlap portion where the carrier strip overlaps the bottom strip. The securing strap can be located above the overlap portion and centered above the overlap portion if desired. The overlap portion can have a width (e.g., 2.5-4 inches) that is greater than the width of the securing strap (e.g., 2 inches). In addition, operation 2540 can include welding the carrier strip and bottom strip to the first cover section and second cover section. This can, for example, include welding the bottom strip to a top side of the first section of the cover and welding the carrier strip to a top side of a second section of the cover, as illustrated in FIG. 22. This can, in another example, include welding the bottom strip to a top side of the first section of the cover and a top side of the second section of the cover and welding the carrier strip to a top side of the bottom strip and the top side of the second section of the cover, as illustrated in FIG. 24.

Method 2500 can be carried out in a fabrication facility. In some examples, multiple sections of cover can heat welded together and every third or fourth seam between sections can be heat welded together using a wide strip by carrying out method 2500. While the illustrated cross-sectional side views of FIGS. 21-24 show a securing strap centered between cover sections, in other examples, the securing strap can be offset toward one of the cover sections. In addition, a wide strip under any of the above embodiments can also carry multiple securing straps welded or stitched to the wide strip.

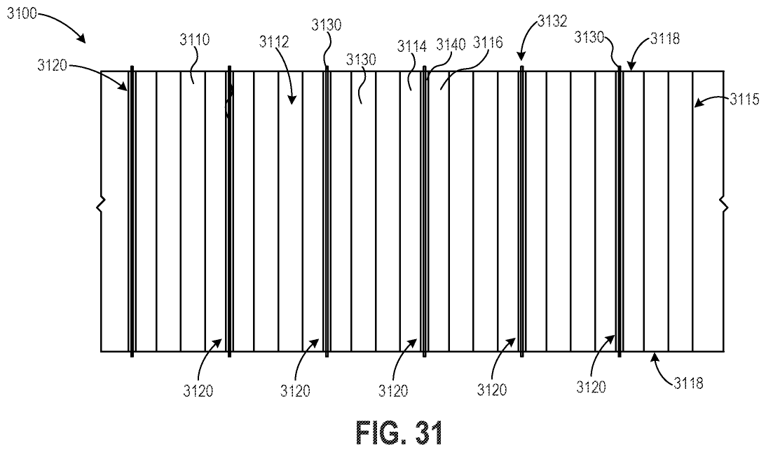

FIG. 31 illustrates another example covering and strapping system 3100 according to embodiments of the present subject matter. The system 3100 includes a cover 3110 having a top side 3112 and a bottom side (not shown). The cover 3110 can be similar to cover 110 discussed above. The cover 3110 can, for example, be formed from a series of sections welded together. For instance, a first section of the cover 3114 can be welded together with a second section 3116 of the cover 3110 using a wide strip 3140 (discussed below). Other adjacent sections can be welded directly to one another, e.g., as shown at a seam 3115.

The system 3100 further includes securing straps/attachment implement system 3120 attached to the top side 3112 of the cover 3110. In an example, the systems 3120 have one or more securing straps 3130. The one or more securing straps 3130 can have securing strap ends 3132 overhanging an edge 3118 of the cover 3110. The securing straps 3130 can extend beyond the edge 3118 of the cover 3110 for securing to a structure. In some examples, every fourth pair of adjacent sections is weld connected by the wide strip 3140 carrying the securing strap 3130.

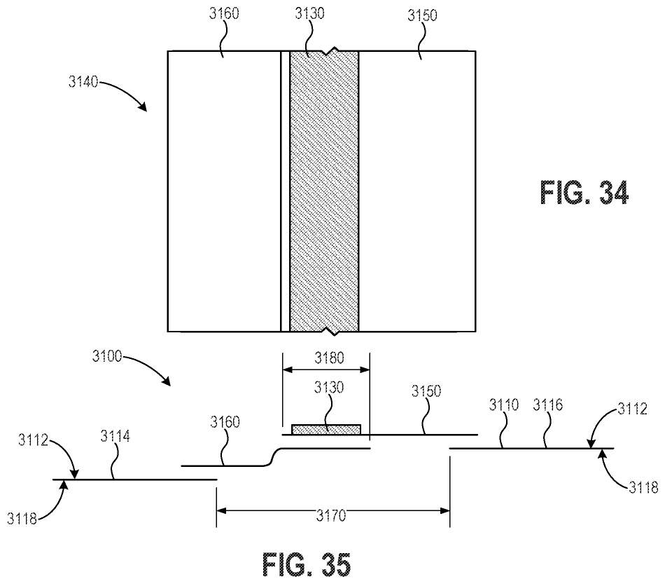

In some examples, a wide strip 3140 carrying the securing strap 3130 can connect (e.g., by welding) adjacent cover sections. FIG. 31 illustrates an example covering and strapping system 3100 with wide strips 3140 connecting adjacent cover sections, according to embodiments of the present subject matter. In these embodiments, the system 3100 includes multiple wide strips 3140 connected (e.g., welded) to the cover 3110 and connecting adjacent cover sections (e.g., as shown in FIGS. 31-36) with a securing strap 3130 connected (e.g., stitched) to each wide strip 3140. The cover 3110 can be similar to cover 110 discussed above. The wide strips 3140 can be formed from the same material as the cover 3110 and can be welded to the cover using heat welding. FIG. 34 is a top view an example wide strip 3140 including, for example, a carrier strip 3150 and a bottom strip 3160. The securing strap 3130 can be connected to the carrier strip 3150. The carrier strip can be connected to the bottom strip 3160. The wide strip 3140 can be connected to one or more of the cover sections, for instance the first section 3114 and the second section 3116 of the cover 3100. In an example, the securing strap 3130 is attached to the wide strip 3140 and connected to the top side 3112 of the cover 3110 without running through a tunnel.

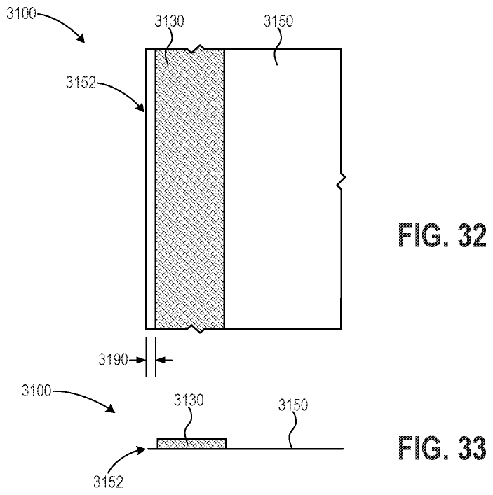

FIG. 35 is a side view of the wide strip 3140 over two sections 3114, 3116 of the cover 3110 where the wide strip 3140 includes the carrier strip 3150 and the bottom strip 3160 and connects the cover sections 3114, 3116. In some examples, the cover sections 3114, 3116 are separated by a gap 3170. For instance, the wide strip 3140 can span between the gap 3170. In this example, the carrier strip 3150 overlaps the bottom strip 3160 in an overlap portion 3180 and the overlap portion 3180 lies in the gap 3170 between the cover sections 3114, 3116. The securing strap 3130 can be stitched or welded to the wide strip 3140 and can be located in the overlap portion 3180. The overlap portion 3180 can have a width that is greater than the width of the securing strap 3130. For example, each of the carrier strip 3150 and the bottom strip 3160 can have a width, for example 6 inches. The overlap portion 3180 can have a width of, for example, 2 inches. Accordingly, the wide strip 3140 can have a width of, for example 10 inches. The width of the wide strip 3140 can vary depending on the application, provided there is suitable amount of overlap with an adjacent cover section to weld the wide strip 3140 to the cover section. In another example, the securing strap 3130 is spaced from an edge 3152 (shown in FIG. 32) of the carrier strip 3150 by a gap 3190 (shown in FIG. 32).

In an example, the cover sections 3114, 3116 can lie beneath the bottom strip 3160 and the carrier strip 3150 and outside of the overlap portion 3180. For instance, the wide strip 3140 can be connected with the top side 3112 of the cover sections 3114, 3116. In another example, the cover sections 3114, 3116 can lie above the bottom strip 3160 and the carrier strip 3150 and outside of the overlap portion 3180. For instance, the wide strip 3140 can be connected with a bottom side 3118 of the cover sections 3114, 3116. As will be discussed further below, the carrier strip 3150 carrying the securing strap 3130 and the bottom strip 3160 can be heat welded to the cover sections 3114, 3116. This can secure the wide strip 3140 and strap 3130 to the cover 3110 and also connect the adjacent cover sections 3114, 3116 in a single step. For example, the bottom strip 3160 can be welded to the top side 3112 of the first cover section 3114, and the carrier strip 3150 can be welded to the top side 3112 of the second cover section 3116. Where the securing strap 3130 is stitched to the carrier strip 3150, the bottom strip 3160 can provide a seal under the stitching and help prevent water from entering the cover 3110.

In some examples, the wide strip 3140 can be cut along the sides of the securing strap 3130 and a portion of the wide strip (e.g., the carrier strip 3150, or the like) can remain below the securing strap 3130, for instance where the securing strap 3130 overhangs an edge 3118 (shown in FIG. 31) of the cover 3110. The securing strap 3130 overhanging the edge 3118 of the cover can be secured to a structure. Accordingly, the securing strap 3130 can secure the cover 3110 to the structure.

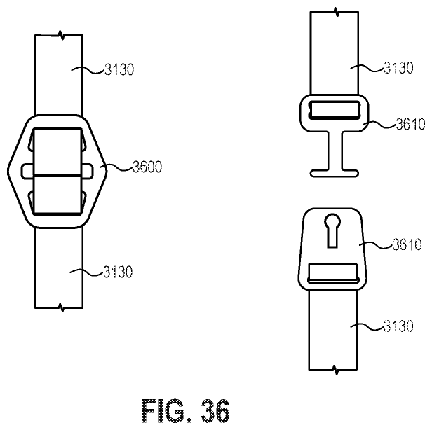

The shape of the cover 3110 is provided by way of illustration. The cover 3110 can be made in a number of different shapes including rectangular (as illustrated in FIG. 31), oval, or circular, as examples. With circular covers, a cover is typically made up of four quarter circle panels. In these designs, the securing straps 3130 can run from an outside end of a quarter panel (for securing the strap to a structure) to an inside end. At the inside ends of adjacent quarter panels, ends of two securing straps can be connected using one or more of a buckle 3600 or a clasp 3610 (e.g., a hook, T-lock, or the like. FIG. 36 shows an example buckle 3600 and the clasp 3610. In an example, one or more of the buckle 3600 or the clasp 2600 are adjustable, for instance to allow tightening or loosening of the securing strap 3130.

Covers with a Carrier Strip as an Attachment Implement

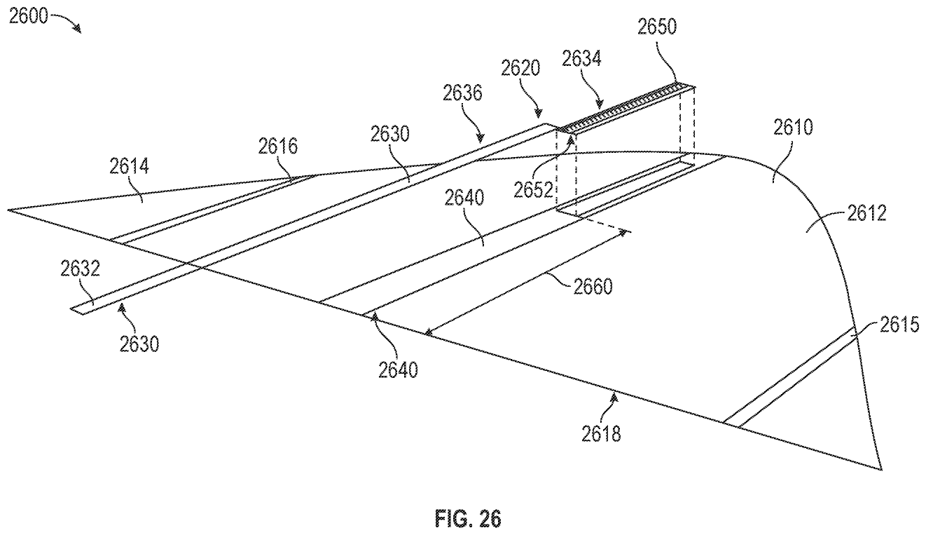

FIG. 26 illustrates another example covering and strapping system 2600 according to embodiments of the present subject matter. The system 2600 includes a cover 2610 having a top side 2612 and a bottom side (not shown). The cover 2610 can be similar to cover 110 discussed above. The cover 2610 can, for example, be formed from a series of sections welded together. For instance, a first section of the cover 2614 can be welded together with a second section 2616 of the cover at a seam 2615.

The system 2600 further includes securing straps/attachment implement system 2620 attached to the top side 2612 of the cover 2610. In an example, the systems 2620 have one or more securing straps 2630. The one or more securing straps 2630 can have securing strap ends 2632 overhanging an edge 2618 of the cover 2610. The securing straps 2630 can extend beyond the edge 2618 of the cover 2610 for securing to a structure. In some examples, each section has at least one of the securing straps 2630, for instance running down the middle of a section along its length.

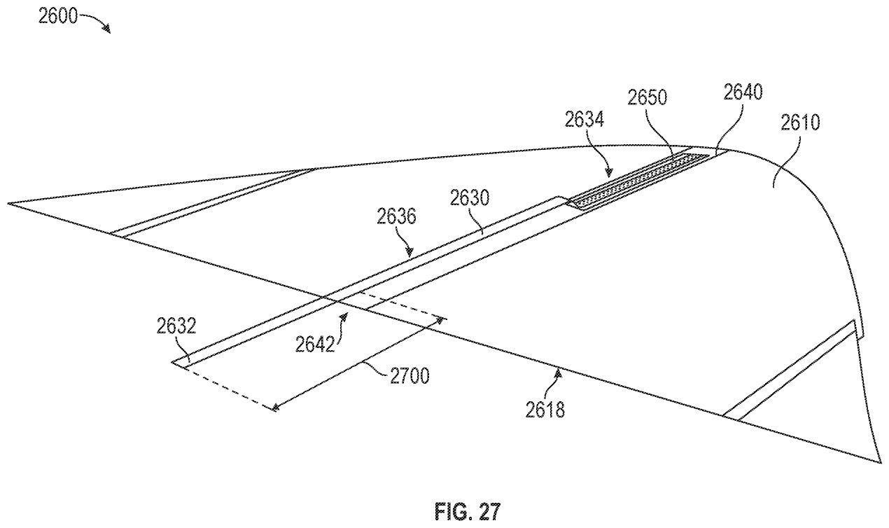

The system 2620 can include a cover strap 2640 connected (e.g., welded) to the top side 2612 of the cover 2610. With reference to FIG. 27, each cover strap 2640 has a cover strap end 2632 at or near the edge 2618 of the cover 2610. For instance, the cover strap 2640 can extend across the top side 2112 of the cover 2610. The cover strap 2640 can be connected to the cover 2610 between the seams 2615. In another example, the cover strap 2640 can overlap at least a portion of the seam 2615.

The system 2620 can include a carrier strip 2650 connected to the cover strap 2640, for instance using heat welding, bonding, or the like. FIG. 26 illustrates the placement of the carrier strip 2650 prior to connection with the cover strap 2640. The securing strap 2630 can be connected with the carrier strip 2650. For example, the securing strap 2630 can be stitched or welded to the carrier strip 2650. In another example, a carrier portion 2634 of the securing strap 2630 can include portions of the securing strap 2630 connected with the carrier strip 2650. For example, the carrier portion 2634 can be 4 feet long (however the present subject matter is not so limited). The system 2620 can include a free portion 2636 of the securing strap 2630 disconnected from the carrier strip 2650. For instance, the free portion 2636 of the securing strap 2630 can be 12 feet long (however the present subject matter is not so limited) and overhand the edge 2618 of the cover 2610. In another example, the strap end 2632 can be disconnected from the carrier strip 2650. Accordingly, the free portion 2636 of the securing strap 2630 can extend from the carrier portion 2634 of the securing strap 2630 that is connected with the carrier strip 2650. Where the securing strap 2630 is stitched to the carrier strip 2650, the cover strap 2640 can provide a seal under the stitching and help prevent water from entering the cover 2610 (or material stored under the cover 2610). Thus, the securing strap 2630 can be indirectly attached to the cover 2610 using one or more of the carrier strip 2650 or the cover strap 2640.

The cover strap 2640 can have a width greater than a width of the carrier strip 2650. The carrier strip 2650 can have a width greater than a width of the securing strap 2630. For instance, the cover strap 2640 can have a width of 6 inches. The carrier strip 2640 can have a width of 2 inches. The securing strap 2630 can have a width of 2 inches. While illustrated in the figures as having the dissimilar width, the cover strap 2640 can have similar width as one or more of the securing strap 2630 or the carrier strip 2650.

As described herein, the carrier strip 2650 can be connected with the cover strap 2640. The carrier strip 2650 can be spaced from the edge 2618 of the cover 2610 by a carrier gap 2660. The carrier gap 2660 can be 6 feet long (however the present subject matter is not so limited). In an example, an end 2652 of the carrier strip 2650 can be spaced by the carrier gap 2660 from the edge 2618 of the cover 2610. The carrier portion 2634 of the securing strap 2630 can be spaced by the carrier gap 2660 from the edge 2618 of the cover 2610. The carrier gap 2660 can be 6 feet long, however the present subject matter is not so limited. The free portion 2636 of the securing strap 2630 (that is disconnected from the carrier strip 2650) can be located within (or extend through) the carrier gap 2660. Accordingly, the cover strap 2640 can be located between the free portion 2636 of the securing strap 2630 and the cover 2610. The carrier strip 2650 can be located between the carrier portion 2634 of the securing strap 2630 and the cover strap 2640.

Spacing of the carrier strip 2630 from the edge 2618 can minimize damage to the cover 2610. For example, the securing strap 2630 can flex (e.g., whip, fluctuate, flap, or the like) in wind moving covering and strapping system 2600. Flexing of the securing strap 2630 can cause the securing strap 2630 to engage with the cover 2610, for instance along the edge 2618. Spacing of the carrier strip 2630 from the edge 2618 can minimize flexing of the carrier strip 2630 along the edge 2618 of the cover 2610. Accordingly, spacing of the carrier strip 2650 at the carrier gap 2660 from the edge 2618 can minimize engagement of the securing strap 2630 with the edge 2618. Thus, damage (e.g., chafing, cutting, wearing, abrasion, or the like) to the edge 2618 (or proximate to the edge 2618) of the cover 2610 can be minimized by spacing the carrier strip 2650 from the edge 2618 of the cover 2610. One or more of the securing strap 2630, the cover strap 2640, or the carrier strip 2650 can include a woven webbing (e.g., N30 strap, or the like), a string reinforced plastic strap, or the like.

FIG. 27 illustrates the carrier strip 2650 can be connected with the cover strip 2640. Accordingly, the carrier portion 2634 of the securing strap 2630 can be indirectly connected with the cover 2610. The free portion 2636 of the securing strap 2630 can be disconnected from the cover 2610 (in correspondence with the carrier portion 2634 indirectly connected with the cover 2610). The end 2632 of the securing strap 2630 (included in the free portion 2636 of the securing strap 2630) can extend beyond the edge 2618 of the cover 2610. For instance, the end 2632 can extend beyond the edge 2618 by an overhang dimension 2700. Accordingly, the end 2632 of the securing strap 2630 can be spaced from the end 2652 (shown in FIG. 26) of the carrier strip 2652 by the carrier gap 2660 (shown in FIG. 26) and the overhang dimension 2700 (shown in FIG. 27).

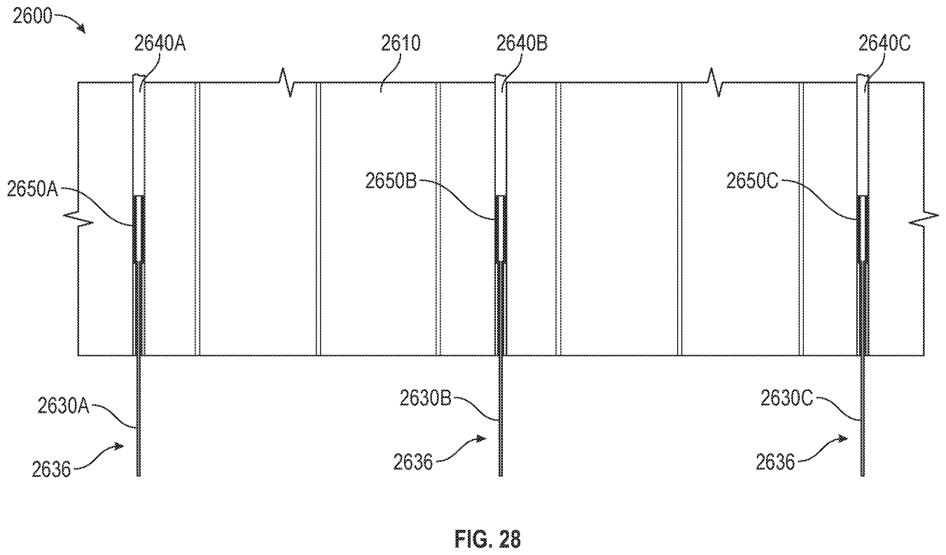

FIG. 28 shows a top view of the covering and strapping system 2600. The securing straps/attachment implement system 2620 can include a plurality of the securing straps 2630, the cover straps 2640, and the carrier strips 2650. For instance, a first securing strap 2630A can be indirectly connected to the cover 2610 using a first carrier strip 2650A and a first cover strap 2640A. A second securing strap 2630B can be indirectly connected to the cover 2610 using a second carrier strip 2650B and a second cover strap 2640B. A third securing strap 2630C can be indirectly connected to the cover 2610 using a third carrier strip 2650B and a third cover strap 2640C. The free portion of the securing straps 2630A, 2630B, 2630C can extend beyond the edge of the cover 2610. The first securing strap 2630A can be centered over (e.g., connected in the middle of, or the like) the first carrier strip 2650A. The first carrier strip 2650A can be centered over the first cover strap 2640A.

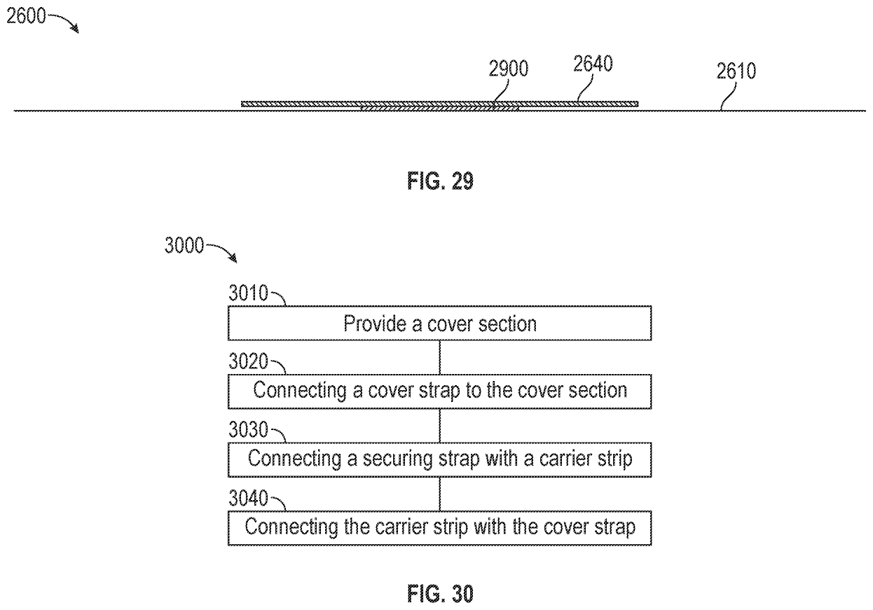

FIG. 29 shows a schematic diagram of the securing straps/attachment implement system 2620. The cover strap 2640 can be connected with the cover 2610, for instance using a continuous fusion weld 2900. The continuous fusion weld 2900 can be centered on the cover strap 2640. The continuous fusion weld 2900 can be 2 inches in diameter. Accordingly, a portion of the cover strap 2640 can be connected with the cover 2610 using the continuous fusion weld 2900.

FIG. 30 illustrates a method 3000 of manufacturing a covering and strapping system, for example the covering and strapping system 2600. The method 3000 includes at operation 3010 providing a cover section, for example section 2612 (shown in FIG. 26). The cover section can be made from a string-reinforced plastic sheet such as Dura-Skrim. At operation 3020, a cover strap, for instance the cover strap 2640 (shown in FIG. 26) can be connected to the cover section. For instance, the continuous fusion weld 2900 (shown in FIG. 29) can be used to connect the cover strap with the cover section.

At operation 3030, a securing strap can be connected with a carrier strip. For example, the securing strap 2630 (shown in FIG. 26) can be connected with the carrier strip 2650 (shown in FIG. 26). The connection can use one or more of stitching or welding to connect the securing strap with the carrier strip. The method 3000 can include at operation 3040, connecting the carrier strip with the cover strap. Accordingly, the securing strap can be indirectly connected with the cover section using one or more of the cover strap or the carrier strip.

### General Comments

The attachment implements in the above methods can be directly attached to the cover (e.g., by adhering, welding, or stitching) or can be indirectly attached to the cover through other elements (e.g., welded to an intermediate fabric layer which is welded to a cover section, welded to a strengthening layer which is welded to a cover section). The securing straps can be directly attached to the attachment implements (e.g., by stitching, welding, or pinning) and thereby indirectly attached to the cover (e.g., attached to the cover through an attaching element) without being directly attached to the cover or attached to the cover by running through integral tunnels in the cover. In some cases, a securing strap can be attached to its attachment implement using a bonding layer. For example, a tail strap can be welded to a cover strap using an intermediate material. While the above described, methods are discussed with reference to a cover formed by multiple sections, the methods can be used with covers formed from a single piece of material. In such cases, one or more attachment implements and respective securing straps can be placed (e.g., spaced at intervals) along the cover and attached to the cover using aspects of the methods described above, for example. In some examples, a cover section can include multiple attachment implements (e.g., a set of load pads, a wide strip, or a strap) each with a securing strap welded, stitched or pinned to a respective attachment implement. Moreover, an attachment implement and securing strap can be located at any position on a cover section.

As noted above, by virtue of the present subject matter not using straps within integral tunnels on a cover, the covering and strapping system described herein can provide one or more of the following advantages. The present subject matter can be more efficiently made. For example, with the present subject matter, it is unnecessary to stitch or weld a tunnel to a cover and thread a separate strap through the tunnel. The present subject matter can be more efficiently installed. For example, the present subject matter can have straps secured directly or indirectly to a cover thus allowing the straps to be held onto by an installer during installation; with freely moveable straps in tunnels, the straps cannot be used as a handhold. Freely moveable straps in tunnels can also become lost in the tunnel during install, such as when an installer tugs on one end of the strap and the other end slides into the tunnel. The present subject matter can have a lower profile, can be more aerodynamic, and can be stronger and more durable than covers with straps in integral tunnels, especially where the present subject matter has straps attach to the top of the cover using welds.

### Various Notes & Aspects

Example 1 is a covering and strapping system, comprising: a cover made having a top side and a bottom side; multiple attachment implements connected to the top side of the cover; and a plurality of securing straps, each of the securing straps being connected to a respective attachment implement and thereby connected to the top side of the cover without running through a tunnel.

In Example 2, the subject matter of Example 1 optionally includes wherein the multiple attachment implements are stitched or welded or adhesively adhered to the cover.

In Example 3, the subject matter of Example 2 optionally includes wherein each of the plurality of securing straps is stitched or welded or pinned to the respective attachment implement.

In Example 4, the subject matter of any one or more of Examples 1-3 optionally include wherein each of the multiple attachment implement comprises a set of load pads connected to the top side of the cover and, and the system further includes one or more tags connecting each of the load pads to a respective securing strap.

In Example 5, the subject matter of Example 4 optionally includes wherein each load pad has a footprint and is adhesively secured to the top of the cover with an adhesive layer having a footprint, the load pad footprint being greater than the footprint of the adhesive layer.

In Example 6, the subject matter of Example 5 optionally includes wherein the one or more tags are breakaway tags, and wherein the load pad includes a pinning tab through which the one or more breakaway tags is inserted.

In Example 7, the subject matter of any one or more of Examples 4-6 optionally include wherein the load pad and cover are made from the same material.

In Example 8, the subject matter of any one or more of Examples 1-7 optionally include wherein each of the multiple attachment implements comprises a cover strap directly connected to the top of the cover, each of the cover straps having ends at or near edges of the cover, wherein the plurality of securing straps include tail straps, each tail strap having a first end directly connected to a cover strap at or near one of the ends of the cover strap and a second end extending beyond the edge of the cover.

In Example 9, the subject matter of Example 8 optionally includes wherein the cover strap is welded to the cover and the tail straps are stitched to the cover strap.

In Example 10, the subject matter of Example 9 optionally includes wherein the tail strap is connected to the cover strap at a location spaced from the edge of the cover.

In Example 11, the subject matter of any one or more of Examples 1-10 optionally include wherein each of the multiple attachment implements comprise a wide strip connected to the top side of the cover, the wide strip having a width, and wherein each of securing straps is connected to a respective wide strip and has a width less than a width of the respective wide strip.

In Example 12, the subject matter of Example 11 optionally includes wherein each wide strip is welded to the top of the cover and a respective securing strap is stitched to the wide strip without being directly stitched to the cover.

In Example 13, the subject matter of Example 12 optionally includes wherein the cover has first and second edges, each of the wide strip extends from at or near the first edge of the cover to at or near the second edge of the cover, and each narrow strap extends beyond the first and second edges of the cover.

In Example 14, the subject matter of any one or more of Examples 1-13 optionally include wherein the cover includes at least a first cover section and a second cover section, the first and second cover sections being overlap welded together along a seam line, wherein each attachment implement and respective securing strap is located along a line parallel to a seam line.

In Example 15, the subject matter of any one or more of Examples 3-14 optionally include a strengthening layer provided between the attachment implement and the cover.

Example 16 is a covering and strapping system, comprising: a cover section made having a top side and a bottom side; an attachment implement connected to the top side of the cover section; and at least one securing strap connected to the attachment implement and thereby indirectly connected to the top side of the cover section without running through a tunnel.

In Example 17, the subject matter of Example 16 optionally includes wherein the system includes multiple cover sections welded together to form a cover, wherein a respective attachment implement of a respective cover section is welded or adhered to a respective cover section, and wherein the at least one securing strap of a respective cover section is stitched or pinned to the respective attachment implement.

Example 18 is a method of manufacturing a covering and strapping system, comprising: a) providing a cover section have a top side and a bottom side; b) connecting an attachment implement to the top side of the cover section; and c) connecting a securing strap to the attachment implement to thereby connect the securing strap to the top side of the cover section without the securing strap running through a tunnel.

In Example 19, the subject matter of Example 18 optionally includes wherein connecting the attachment implement includes stitching or welding or adhering the attachment implement to the cover section.

In Example 20, the subject matter of Example 19 optionally includes wherein connecting the securing strap includes stitching or welding or pinning the securing strap to the attachment implement.

In Example 21, the subject matter of any one or more of Examples 18-20 optionally include wherein connecting the attachment implement includes connecting a set of load pads to the cover section, wherein connecting the securing strap includes pinning the securing strap each of the load pads with one or more tags.

In Example 22, the subject matter of Example 21 optionally includes wherein connecting the attachment implement includes adhering each of the load pads to the cover section with an adhesive layer, each load pad having a footprint that is greater than a footprint of the adhesive layer.

In Example 23, the subject matter of any one or more of Examples 21-22 optionally include wherein pinning includes inserting the tab through pinning tabs of the load pads.

In Example 24, the subject matter of any one or more of Examples 21-23 optionally include forming the load pads and cover section from the same material.

In Example 25, the subject matter of any one or more of Examples 18-24 optionally include wherein connecting the attachment implement includes connecting a cover strap to the top of the cover section so the cover straps run to or near the edges of the cover section; and connecting the securing strap includes connecting a tail strap to each end the cover strap.

In Example 26, the subject matter of Example 25 optionally includes wherein the cover strap is welded to the cover section and the tail straps are stitched to the cover strap.

In Example 27, the subject matter of Example 26 optionally includes wherein each tail strap is connected to the cover strap at a location spaced from the edge of the cover section.

In Example 28, the subject matter of any one or more of Examples 18-27 optionally include wherein connecting an attachment implement includes connecting a wide strip to the cover section.

In Example 29, the subject matter of Example 28 optionally includes wherein connecting the securing strap includes connecting the securing strap to the wide strip, the securing strap having a width less than a width of the wide strip.

In Example 30, the subject matter of Example 29 optionally includes wherein the wide strip is welded to the top of the cover section and the securing strap is stitched to the wide strip without being directly stitched to the cover section.

In Example 31, the subject matter of any one or more of Examples 28-30 optionally include wherein the cover section has first and second edges, wherein the wide strip extends from at or near the first edge of the cover section to at or near the second edge of the cover, and wherein the securing strap extends beyond the first and second edges of the cover section.

In Example 32, the subject matter of any one or more of Examples 28-31 optionally include wherein the securing strap is connected to the wide strip before the wide strip is connected to the cover section, the securing strap and wide strip forming a composite strip connected to the cover section.

In Example 33, the subject matter of any one or more of Examples 18-32 optionally include overlap welding at least a first section and a second section of the cover along an overlap seal line; wherein connecting the plurality of securing straps to the multiple attachment implements includes connecting a respective securing strap to the one or more respective ones of the multiple attachment implements along a line parallel to the overlapping seal line.

In Example 34, the subject matter of any one or more of Examples 18-33 optionally include repeating operations a)—c) for multiple cover sections.

In Example 35, the subject matter of Example 34 optionally includes welding the multiple cover sections together along seam lines to form a cover.

Example 36 is a method of manufacturing a covering and strapping system for granular product, comprising: providing a cover have a top side and a bottom side; and connecting multiple attachment implements to the top side of the cover; and connecting a plurality of securing straps to the multiple attachment implements, including connecting each of the securing straps to a respective attachment implement to thereby connect the securing straps to the top side of the cover without running through a tunnel.

In Example 37, the subject matter of Example 36 optionally includes wherein connecting the multiple attachment implements includes stitching or welding or adhering the attachment implements to the cover.

In Example 38, the subject matter of any one or more of Examples 36-37 optionally include wherein connecting the securing straps includes stitching or welding or pinning each of the securing straps to a respective attachment implement.

In Example 39, the subject matter of any one or more of Examples 36-38 optionally include wherein connecting multiple attachment implements includes connecting a strengthening layer to the cover and connecting an attachment implement to the strengthening layer.

Example 40 is a covering and strapping system, comprising: a cover having a first section and a second section and a seam between the first section and second section; a wide strip connected to a top side of the cover over the seam; and a securing strap attached to the wide strip over the seam and thereby connected to the top side of the cover without running through a tunnel.

In Example 41, the subject matter of Example 40 optionally includes wherein the wide strip has a width and the securing strap has a width less than a width of the wide strip.

In Example 42, the subject matter of any one or more of Examples 40-41 optionally include wherein the wide strip is welded to the top of the cover and the securing strap is stitched to the wide strip without being directly stitched to the cover.

In Example 43, the subject matter of Example 42 optionally includes wherein the wide strip includes a carrier strip and a bottom strip, wherein the carrier strip overlaps the bottom strip in an overlap portion, and wherein the securing strap is stitched to the carrier strip in the overlap portion.

In Example 44, the subject matter of Example 43 optionally includes wherein the overlap portion has a width that is greater than the width of the securing strap.

In Example 45, the subject matter of Example 44 optionally includes inches.

In Example 46, the subject matter of any one or more of Examples 43-45 optionally include wherein the first and second cover sections lie beneath the overlap portion.

In Example 47, the subject matter of any one or more of Examples 43-46 optionally include wherein first and second cover sections lie outside of the overlap portion.

In Example 48, the subject matter of any one or more of Examples 43-47 optionally include wherein the securing strap is centered between the first and second cover sections.

In Example 49, the subject matter of any one or more of Examples 46-48 optionally include wherein bottom strip is welded to a top side of the first section of the cover and wherein the carrier strip is welded to the top side of the second section of the cover.

In Example 50, the subject matter of any one or more of Examples 42-49 optionally include wherein the wide strip is welded to the first section of the cover and the second section of the cover.

In Example 51, the subject matter of Example 50 optionally includes wherein the securing strap is centered between the cover sections.

Example 52 is a method of manufacturing a covering and strapping system, comprising: providing a cover having a first section and a second section and a seam therebetween; connecting a securing strap to a wide strip; and connecting the wide strip to a top side of the cover, including connecting the wide strip to the first and second sections of the cover, to thereby connect the securing strap to the top side of the cover without the securing strap running through a tunnel.

In Example 53, the subject matter of Example 52 optionally includes wherein connecting the securing strap includes stitching the securing strap to the wide strip before connecting the wide strip to the top side of the cover.

In Example 54, the subject matter of Example 53 optionally includes wherein the securing strap has a width less than a width of the wide strip.

In Example 55, the subject matter of any one or more of Examples 53-54 optionally include wherein connecting the wide strip to the top side of the cover includes welding the wide strip to the top of the cover.

In Example 56, the subject matter of Example 55 optionally includes wherein connecting the wide strip to the top side of the cover includes welding the wide strip to the first cover section and the second cover section.

In Example 57, the subject matter of Example 56 optionally includes wherein the wide strip includes a carrier strip and the bottom strip, wherein connecting the securing strap to the wide strip includes connecting the securing strap to the carrier, wherein the method includes overlapping the carrier strip and the bottom strip and wherein welding the wide strip to the first cover section and the second cover section over the seam includes welding the carrier strip and bottom strip to the first cover section and second cover section.

In Example 58, the subject matter of Example 57 optionally includes wherein connecting the securing strap to the wide strip includes stitching the securing strap to the carrier strip.

In Example 59, the subject matter of any one or more of Examples 57-58 optionally include wherein overlapping the carrier strip and the bottom strip includes forming an overlap portion of the wide strip.

In Example 60, the subject matter of Example 59 optionally includes wherein overlapping the carrier strip and the bottom strip includes placing the securing strap in the overlap portion.

In Example 61, the subject matter of Example 60 optionally includes wherein the securing strap is centered in the overlap portion.

In Example 62, the subject matter of any one or more of Examples 60-61 optionally include wherein the overlap portion has a width that is greater than the width of the securing strap.

In Example 63, the subject matter of any one or more of Examples 57-62 optionally include wherein welding the carrier strip and bottom strip to the first cover section and second cover section includes welding the bottom strip to a top side of the first section of the cover and welding the carrier strip to the top side of the second section of the cover.

Example 64 is a covering and strapping system, comprising: a cover having a top side and a bottom side; an attachment implement connected to the top side of the cover; and a securing strap, the securing strap being connected to the attachment implement and thereby connected to the top side of the cover without running through a tunnel.

Example 65 is a method of manufacturing a covering and strapping system, comprising: providing a cover having a top side and a bottom side; connecting a securing strap to an attachment implement; and connecting the attachment implement to the top side of the cover to thereby connect the securing strap to the top side of the cover without the securing strap running through a tunnel.

Example 66 is a covering and strapping system, comprising: a cover having a top side, a bottom side, and an edge; at least one attachment implement connected to the top side of the cover; and a securing strap having a first portion connected with the attachment implement, wherein the first portion of the securing strap connected with the attachment implement is spaced from the edge of the cover.

In Example 67, the subject matter of Example 66 optionally includes wherein the at least one attachment implement includes a carrier strip, and the carrier strip is located between the first portion of the securing strap and the cover.

In Example 68, the subject matter of Example 67 optionally includes a cover strap directly connected to the top side of the cover, wherein the carrier strip is located between the securing strap and the cover strap.

In Example 69, the subject matter of Example 68 optionally includes wherein the carrier strip is connected with the cover strap.

In Example 70, the subject matter of any one or more of Examples 68-69 optionally include wherein the cover strap extends to the edge of the cover.

In Example 71, the subject matter of Example 70 optionally includes wherein the securing strap has a second portion disconnected from the carrier strip, and the cover strap is located between the cover and the second portion of the securing strap.

In Example 72, the subject matter of Example 71 optionally includes wherein the second portion of the securing strap extends beyond the edge of the cover.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A covering and strapping system, comprising:
a cover made having a top side and a bottom side;
multiple attachment implements connected to the top side of the cover; and
a plurality of securing straps, each of the securing straps being connected to a respective attachment implement and thereby connected to the top side of the cover without running through a tunnel.

2. The covering and strapping system of claim 1, wherein the multiple attachment implements are stitched or welded or adhesively adhered to the cover.

3. The covering and strapping system of claim 2, wherein each of the plurality of securing straps is stitched or welded or pinned to the respective attachment implement.

4. The covering and strapping system of claim 1, wherein each of the multiple attachment implement comprises a set of load pads connected to the top side of the cover and, and the system further includes one or more tags connecting each of the load pads to a respective securing strap.

5. The covering and strapping system of claim 4, further wherein each load pad has a footprint and is adhesively secured to the top of the cover with an adhesive layer having a footprint, the load pad footprint being greater than the footprint of the adhesive layer.

6. The covering and strapping system of claim 5, wherein the one or more tags are breakaway tags, and wherein the load pad includes a pinning tab through which the one or more breakaway tags is inserted.

7. The covering and strapping system of claim 4, wherein the load pad and cover are made from the same material.

8. The covering and strapping system of claim 1, wherein each of the multiple attachment implements comprises a cover strap directly connected to the top of the cover, each of the cover straps having ends at or near edges of the cover, wherein the plurality of securing straps include tail straps, each tail strap having a first end directly connected to a cover strap at or near one of the ends of the cover strap and a second end extending beyond the edge of the cover.

9. The covering and strapping system of claim 8, wherein the cover strap is welded to the cover and the tail straps are stitched to the cover strap.

10. The covering and strapping system of claim 9, wherein the tail strap is connected to the cover strap at a location spaced from the edge of the cover.

11. The covering and strapping system of claim 1, wherein each of the multiple attachment implements comprise a wide strip connected to the top side of the cover, the wide strip having a width, and wherein each of securing straps is connected to a respective wide strip and has a width less than a width of the respective wide strip.

12. The covering and strapping system of claim 11, wherein each wide strip is welded to the top of the cover and a respective securing strap is stitched to the wide strip without being directly stitched to the cover.

13. The covering and strapping system of claim 1, wherein the cover includes at least a first cover section and a second cover section, the first and second cover sections being overlap welded together along a seam line, wherein each attachment implement and respective securing strap is located along a line parallel to a seam line.

15. The covering and strapping system of claim 1, further including a strengthening layer provided between the attachment implements and the cover.

16. A covering and strapping system, comprising:
a cover having a first section and a second section and a seam between the first section and second section;
a wide strip connected to a top side of the cover over the seam; and
a securing strap attached to the wide strip over the seam and thereby connected to the top side of the cover without running through a tunnel.

17. The covering and strapping system of claim 16, wherein the wide strip has a width and the securing strap has a width less than a width of the wide strip.

18. The covering and strapping system of claim 16, wherein the wide strip is welded to the top of the cover and the securing strap is stitched to the wide strip without being directly stitched to the cover.

19. The covering and strapping system of claim 18, wherein the wide strip includes a carrier strip and a bottom strip, wherein the carrier strip overlaps the bottom strip in an overlap portion, and wherein the securing strap is stitched to the carrier strip in the overlap portion.

20. The covering and strapping system of claim 19, wherein the overlap portion has a width that is greater than the width of the securing strap.

21. The covering and strapping system of claim 19, wherein the first and second cover sections lie beneath the overlap portion.

22. The covering and strapping system of claim 19, wherein first and second cover sections lie outside of the overlap portion.

23. A covering and strapping system, comprising:
a cover having a top side, a bottom side, and an edge;
at least one attachment implement connected to the top side of the cover; and
a securing strap having a first portion connected with the attachment implement, wherein the first portion of the securing strap connected with the attachment implement is spaced from the edge of the cover.

24. The covering and strapping system of claim 23, wherein the at least one attachment implement includes a carrier strip, and the carrier strip is located between the first portion of the securing strap and the cover.

25. The covering and strapping system of claim 24, further comprising a cover strap directly connected to the top side of the cover, wherein the carrier strip is located between the securing strap and the cover strap.

26. The covering and strapping system of claim 25, wherein the carrier strip is connected with the cover strap.

27. The covering and strapping system of claim 25, wherein the cover strap extends to the edge of the cover.

28. The covering and strapping system of claim 27, wherein the securing strap has a second portion disconnected from the carrier strip, and the cover strap is located between the cover and the second portion of the securing strap.

29. The covering and strapping system of claim 28, wherein the second portion of the securing strap extends beyond the edge of the cover.
